(19) United States
(12) Patent Application Publication
(10) Pub. No.: US 2009/0107337 A1
(43) Pub. Date: Apr. 30, 2009

(54) AUTOMATIC PULSE CARTRIDGE CLEANING SYSTEM AND METHOD

(76) Inventor: Huong Van Vu, Raytown, MO (US)

Correspondence Address: NIXON & VANDERHYE P.C., 901 NORTH GLEBE ROAD, 11TH FLOOR, ARLINGTON, VA, 22203, US

(21) Appl. No.: 11/931,202

(22) Filed: Oct. 31, 2007

(51) Int. Cl. B01D 41/00

(52) U.S. Cl. 95/279; 55/283; 55/294

(57) ABSTRACT

An inlet air filtration system includes a module configured to receive a gas stream and a plurality of filters supported by the module and configured to direct the gas stream. Each of the plurality of filters is configured to capture particulate matter contained in the gas stream. The system further includes a cleaning assembly movable amongst the filters. The cleaning assembly includes a blow pipe configured to receive a flow of gas, a blow nozzle, and a valve connected to the blow nozzle to blow the flow of gas across the filters to release the captured particulate matter. A method of cleaning an inlet air filtration system includes moving a cleaning assembly amongst the filters to clean the filters.

### BACKGROUND OF THE INVENTION

The invention relates to an automatic pulse cartridge cleaning system for a gas turbine inlet system.

To provide a safe and efficient operation, air entering a gas turbine for power generation applications is filtered. The gas turbine air inlet system may include a filter house and additional inlet ducting. The main ambient air inlet leads to a reduced outlet connected to a gas turbine inlet. Heating air is introduced via a manifold located in the inlet duct, downstream of one or more conventional silencers and the gas turbine inlet. Hot air is bled from the gas turbine compressor and carried via a conduit to the manifold, and controlled by a pressure reducing valve. The hot air bled from the gas turbine compressor may also be mixed with ambient air.

Systems may be provided for controlling the cleaning of industrial filter systems, such as textile barrier filters of the bag filter type, including a plurality of filter houses, such as a plurality of industrial baghouses. Baghouses may be employed, for example, for air pollution control purposes to separate undesirable particulate matter from a gas stream, such as a boiler flue gas stream, by fabric filtration. Fabric filtration is not limited to air pollution control, but may also be employed in resource recovery applications to recover the particulate matter.

Filtration may be carried out in filter houses, known as baghouses, by a plurality of fabric bag filters suspended, generally open-end down, within the baghouse. Particulate laden gas is directed upwardly into each bag such that the particulate matter collects inside the bag as a filter cake. Gas is forced to flow through the baghouse by either a blower fan or a suction fan, and accordingly there is a pressure drop across the filters depending upon their resistance to gas flow. As a filter cake accumulates on the bag surface, gas flow resistance increases, thereby decreasing gas flow and increasing the pressure drop, which must then be overcome by the fan. Accordingly, the bag filters are periodically cleaned to remove the accumulated filter cake.

In order to maintain a bag house in operation while cleaning is taking place, it is known to provide a cleaning cycle whereby individual compartments within a baghouse are cleaned one at a time, while the remaining compartments of the baghouse remain on-line to continue the filtering operation. The compartment that is being cleaned is taken off-line by closing an appropriate damper connecting the compartment being cleaned to the common inlet duct, the common outlet duct, or both. After each compartment is cleaned, it is returned on-line, and the next compartment in sequence is cleaned, and so on, until all compartments of the baghouse have undergone a cleaning cycle. See, for example, U.S. Pat. No. 4,507,130.

Conventional cleaning systems, such as that shown in U.S. Pat. No. 4,507,130, provide an individual air header per row mounted in a stationary configuration with selectivity of the pulsing control being performed by a relay base electronic. Such systems are expensive as they require a plurality of blowers and a complicated control system.

### BRIEF DESCRIPTION OF THE INVENTION

According to one embodiment of the invention, an inlet air filtration system comprises a module configured to receive a gas stream and a plurality of filters supported by the module and configured to direct the gas stream. Each of the plurality of filters is configured to capture particulate matter contained in the gas stream. The system further comprises a cleaning assembly movable amongst the filters. The cleaning assembly comprises a blow pipe configured to receive a flow of gas, a blow nozzle, and a valve connected to the blow nozzle to blow the flow of gas across the filters to release the captured particulate matter.

Another embodiment of the invention is a method of cleaning an inlet air filtration system. The inlet air filtration system for the gas turbine comprises a module configured to receive a gas stream and a plurality of filters supported by the module and configured to direct the gas stream. Each of the plurality of filters is configured to capture particulate matter contained in the gas stream. The system further comprises a cleaning assembly. The cleaning assembly comprises a blow pipe configured to receive a flow of gas, a blow nozzle, and a valve connected to the blow nozzle to blow the flow of gas across the filters to release the captured particulate matter. The method comprises moving the cleaning assembly amongst the filters to clean each filter.

### BRIEF DESCRIPTION OF THE DRAWINGS

FIG. 1 schematically depicts an automatic pulse cartridge cleaning system according to an embodiment of the invention;

FIG. 2 schematically depicts a movable blow pipe assembly according to an embodiment of the invention; and

FIG. 3 schematically depicts a plurality of filters in a filter module according to an embodiment of the invention.

### DETAILED DESCRIPTION OF THE INVENTION

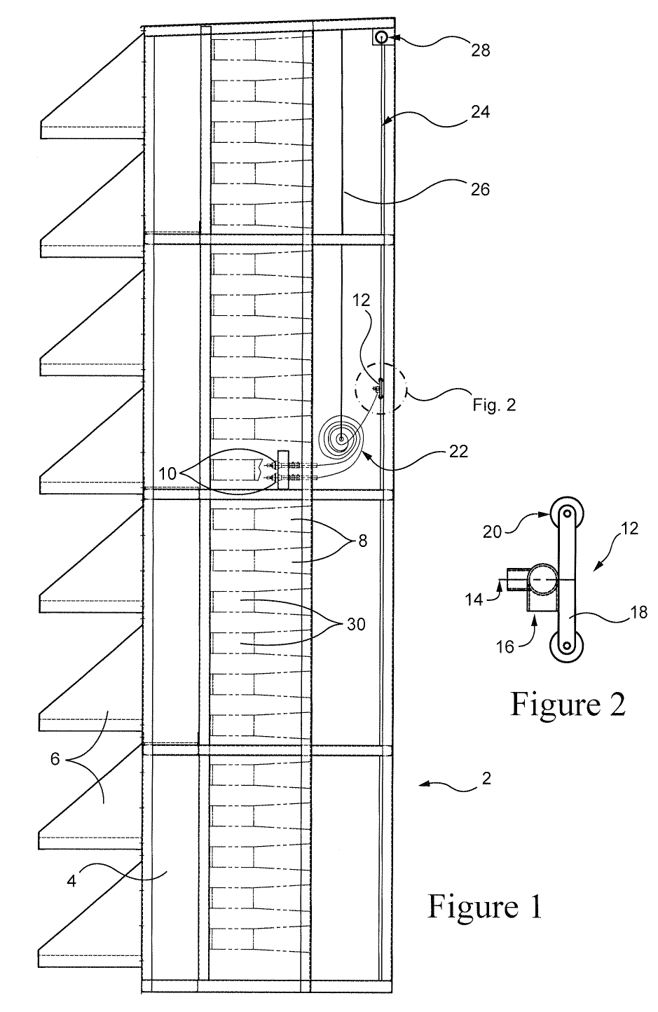

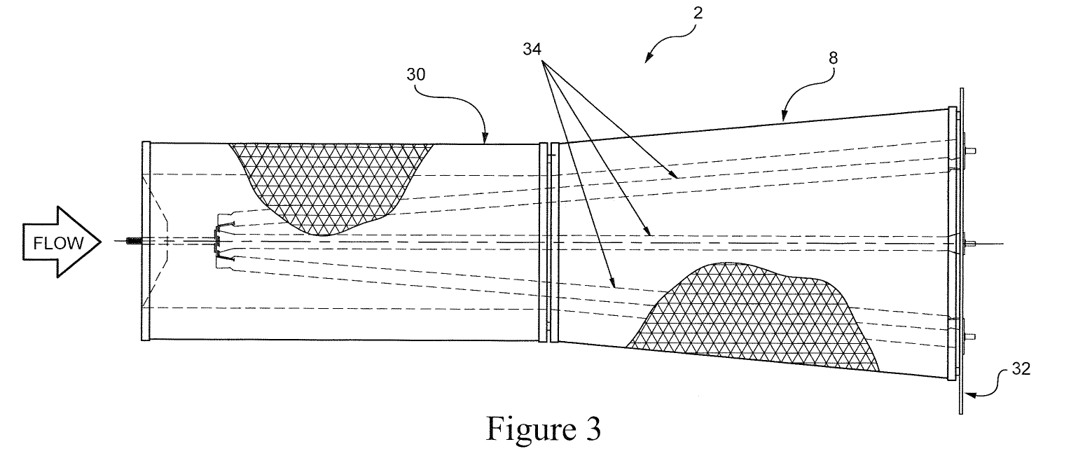

Referring to FIGS. 1 and 2, an automatic pulse cartridge cleaning system includes a filter house 2 having a module 4 and a plurality of inlet hoods 6. The filter house 2 includes a plurality of cartridge filters 8, 30. As shown in FIG. 3, the cartridge filter 8 may be a cylindrical filter cartridge and the cartridge filter 30 may be a conical filter cartridge. The filters 8, 30 may be supported by, for example, a tube sheet 32 and a filter tripod 34.

The filters 8, 30 are cleaned by two valves 10 and a blow nozzle 14. The valves 10 are configured to blow air across the filters 8, 30 in a direction opposite the gas stream to remove particulate matter accumulated in the filters 8, 30.

The blow nozzle 14 is provided on a blow pipe 16 which is carried by a track 18. The blow pipe 16 and blow nozzle 14 are part of a movable blow pipe assembly 12 that is carried by rollers 20 which are engaged with a driving belt 24. The driving belt 24 is driven by a servo controlled motor 28. The valves 10 are connected to the movable blow pipe assembly 12 by a flexible hose and reel assembly 22 which is connected to a retractable cord 26.

The provision of the module including the two valves 10 and the blow pipe 16 reduces the weight of the module and the corresponding electrical load. The provision of the valves 10 and the blow pipe 16 also reduces the cycle time for manufacturing. As fewer components are provided in the air path, the airflow resistance is reduced resulting in improved system performance, for example, a reduced pressure loss across the filter assembly.

The flexible hose reel assembly 22 connects the valves 10 to the blow pipe 16 and the servo controlled motor 28 drives the blow pipe 16 to different rows of filters to clean. The flexible hose of the reel assembly 22 is wound around a reel to release and retract the hose as the blow pipe 16 travels up and down the filter house 2.

As the automatic pulse cartridge cleaning system comprises the single module comprising the two valves 10 and the movable blow pipe assembly 12, the valve and the blow pipe quantities are reduced which results in fewer wires and less labor and material costs. The module also has a smaller control panel with fewer components thereby reducing costs further. The compressed air header is also shorter and as it does not include blow pipes at each row of filters, as in conventional systems, the obstruction of airflow is minimized and the reduced obstruction in the air path reduces the pressure loss and increases system performance. The provision of fewer valves from prior art systems also results in less maintenance and fewer replacement parts for the system.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An inlet air filtration system for a gas turbine, comprising:
a module configured to receive a gas stream;
a plurality of filters supported by the module and configured to direct the gas stream, each of the plurality of filters being configured to capture particulate matter contained in the gas stream; and
a cleaning assembly movable amongst the filters, the cleaning assembly comprising:
a blow pipe configured to receive a flow of gas,
a blow nozzle, and
a valve connected to the blow nozzle to blow the flow of gas across the plurality of filters to release the captured particulate matter.

2. The system of claim 1, wherein the valve is connected to the blow nozzle by a flexible hose.

3. The system of claim 2, wherein the flexible hose is wound on a reel for winding and unwinding as the cleaning assembly moves amongst the filters.

4. The system of claim 3, wherein the reel is supported on a retractable cord.

5. The system of claim 1, wherein the blow pipe and blow nozzle are supported on a movable track.

6. The system of claim 5, wherein the movable track is supported on a driving belt.

7. The system of claim 6, wherein the driving belt is driven by a motor.

8. The system of claim 7, wherein the motor is a servo motor.

9. The system of claim 7, further comprising a controller to control the motor to drive the driving belt.

10. The system of claim 1, wherein the plurality of filters comprise a cylindrical filter and a conical filter.

11. A method of cleaning an inlet air filtration system, the inlet air filtration system comprising
a module configured to receive a gas stream;
a plurality of filters supported by the module and configured to direct the gas stream, each of the plurality of filters being configured to capture particulate matter contained in the gas stream; and
a cleaning assembly comprising
a blow pipe configured to receive a flow of gas,
a blow nozzle, and
a valve connected to the blow nozzle to blow the flow of gas across the filters to release the captured particulate matter, the method comprising:
moving the cleaning assembly amongst the filters to clean the filters.

12. The method of claim 11, wherein the valve is connected to the blow nozzle by a flexible hose.

13. The method of claim 12, further comprising winding and unwinding the flexible hose on a reel as the cleaning assembly moves amongst the filters.

14. The method of claim 13, wherein the reel is supported on a retractable cord.

15. The method of claim 11, wherein the blow pipe and blow nozzle are supported on a movable track.

16. The method of claim 15, wherein the movable track is supported on a driving belt.

17. The method of claim 16, further comprising driving the driving belt by a motor.

18. The method of claim 17, wherein the motor is a servo motor.

19. The method of claim 17, further comprising controlling the motor to drive the driving belt.

20. The method of claim 11, wherein the plurality of filters comprise a cylindrical filter and a conical filter.
